(19) United States
(12) Patent Application Publication
(10) Pub. No.: US 2021/0192215 A1
(43) Pub. Date: Jun. 24, 2021

(54) PLATFORM FOR THE MANAGEMENT AND VALIDATION OF CONTENTS OF VIDEO IMAGES, PICTURE OR SIMILAR, GENERATED BY DIFFERENT DEVICES

(71) Applicant: OCTO TELEMATICS SPA, Rome (IT)

(72) Inventor: Andrea MUNGO, Rome (IT)

(21) Appl. No.: 16/606,288

(22) PCT Filed: Apr. 20, 2018
(86) PCT No.: PCT/IB2018/052749

§ 371 Date: Oct. 18, 2019

(30) Foreign Application Priority Data
Apr. 20, 2017 (IT) 102017000043264

(51) Int. Cl. G06K 9/00; G06K 9/46; G06K 9/62

(52) U.S. Cl. CPC G06K 9/00718; G06K 9/4661; G06K 9/00818; G06K 2009/00738; G06K 9/6276; G06K 9/00744; G06K 9/00825

(57) ABSTRACT

An apparatus and method for detecting if a video image content relating to an event was altered, wherein said apparatus comprises communication means adapted to receive said video content which can be acquired during said road accident by a general-purpose device, processing means in communication with said communication means and configured to search said video content for changes by verifying a plurality of data and/or parameters which are adapted to identify at least one alteration of the video content after the acquisition thereof, and classify the content as altered if the video content contains at least one of said changes, or as authentic and unaltered, if the video content contains no changes.

In a more general aspect, the present invention refers to a platform for the validation of video images, photographic images, audio recordings or other type of contents, generated by different types of apparatuses.

Before proceeding further, it is only necessary to point out that in this description and in the subsequent claims, reference will be made primarily to contents of video images, audio-video data or photographic images, such as movies, photographs, audio recordings and the like, as mentioned above.

This shall be understood in a broad manner, in the sense that such contents can be considered alone or combined, such as, for example, the audio track and the images acquired from the same apparatus, such as a video camera, or those acquired by different devices, such as video cameras, mobile phones and the like, which can also be in different positions.

Furthermore, the photographic images can derive from frames extracted from a video or can be taken by means of dedicated photographic apparatuses.

Thereby, it should be noted that the validation platform according to the present invention is a complex system in which various parts are included; for simplicity and clarity, in the present description and in the subsequent claims, reference will be made predominantly to some of them: this must not however be understood as a limitation, since the scope of the invention and/or the application thereof also extends beyond the apparatus and the various devices considered here.

Therefore, in a more specific aspect thereof, the invention relates to an apparatus and/or a method for detecting whether a content of images, sounds or other video, audio and/or even video/audio data, relating in particular, but not exclusively, to a road accident, is original or has been modified.

In particular, the invention aims at detecting the presence of any alterations made to the image content, in videos, photographs, in audio-video data or the like, acquired by a general-purpose device, i.e., not specifically dedicated, such as, for example, a mobile phone of the so-called smart type (smartphone), a tablet, a video camera or a camera, either analog or digital, nowadays commonly widespread and used.

For example, for the surveillance and security in general of public areas and in particular of roads, the employment of means for acquiring images, whether in the form of video, photographic or audio-video contents to be reproduced on observation screens (i.e., monitors), or detected in another manner (e.g., with infrared or other electromagnetic waves for thermographic, radiographic or other type of images; sonars or other acoustic probes for ultrasound, sonic and other images) is widespread.

Such contents are often used by subjects responsible for the management of traffic routes (e.g., the police, security forces, etc.) or related situations, such as insurance companies managing road accident practices or courts which must decide on legal cases for damages caused by accidents.

Under these circumstances, the use of fixed video cameras at road intersections, traffic lights or predefined points on the road (and motorway) network, or mobile video cameras on board vehicles (also known as ‘dash cams’) is increasingly widespread.

These cameras are used not only to check traffic routes but also, especially in the case of those mounted on board the vehicles, to acquire images from the point of view of the driver, which can possibly be used as evidence in the event of a road accident.

It is however necessary to observe how the usage of video cameras on board cars is rather common in latest-generation models, to allow a view in reversing operations or even as sensors.

These apparatuses for acquiring images (in the form of the various contents mentioned above) can also be used by individuals and ordinary citizens, in addition to road professionals (taxi drivers, truck drivers, security forces, etc.).

Many of these devices allow to detect an impact caused by a road accident by means of an accelerometer and to permanently or semi-permanently store the video stream before, during and after the road accident. It is worth noting that many of these devices are, in fact, mobile telecommunications terminals (i.e., the latest generation of mobile phones, the so-called smartphones) which implement dash cam functions by executing specific applications capable of acquiring a video stream by means of the video sensor of the mobile terminal when the accelerometer of said terminal detects an acceleration of high intensity but of short duration which can be due to an impact suffered by the vehicle.

Representative examples of this background art are described in the publications of the European patent applications EP 2949510 A1 and EP 2950311 A1, of which the current applicant of the present application is the owner.

This wide diffusion of fixed or mobile terminals and apparatuses for generally acquiring images relating to roads, traffic and traffic routes as a whole, has led to an increasingly wide use of heterogeneous devices, which adopt different technologies and/or standards, thus generating an increase in the quantity and complexity of data relating to video contents.

Since the latter are also more and more often used as evidence in the event of a road accident, especially in court, to attribute responsibility for accidents and obtain or establish compensation from insurance companies, it becomes important to ascertain the authenticity of the images taken with the means mentioned above.

In fact, only some (a few) apparatuses are now recognized as reliable and capable of ensuring the authenticity of the contents of video images, audio-video data, photographic images or the like, relating to road accidents; basically, these are apparatuses similar to the black boxes of airplanes, also known as VEDR devices (acronym of Video Event Data Recorder).

Instead, in the case of images acquired by means of other devices, such as fixed surveillance video cameras or mobile ones of mobile phones or dash cams, etc., the reliability of video, audio, photographic contents or the like is not recognized, especially in court.

It is in fact known that current technologies allow to quite easily process and modify images of a film or of photographs in general; this occurs both for professional (e.g., the post-production of television broadcasts or of cinematographic filming) and recreational purposes (people who share videos on-line with friends and acquaintances, or who do it as their own hobby), but the effect is however that of having a diversity or discrepancy between the original and final images of a video or, in any case, of a series of frames.

It is understandable that such a situation is not compatible with the use of video and/or photographic material as documentary evidence in a judicial or insurance process, following a road accident.

As a result, the increase in quantities and the heterogeneity of video or photographic images has made it difficult for insurance companies or other operators in the sector (e.g., courts) to ascertain the authenticity and/or originality of the material examined, i.e., the correspondence between the images acquired and the facts which they refer to.

Usually these assessments require the human intervention of specialized experts, who examine the material and determine whether it is original or not.

It is apparent that, given the limited availability, the (long) time and the relevant (high) costs of experts for carrying out their work, and considering the increasing quantity of images to be evaluated coming from the heterogeneous sources mentioned above (video cameras, camcorders and similar fixed or mobile apparatuses, mobile phones or other devices on board the vehicles), there is a need to find alternatives which can improve the current state of the art.

In fact, the difficulty in attesting the authenticity or originality of video or photographic images increases the risk of falsification or fraud against motorists, public administrations or insurance companies.

Furthermore, the increase in the risk of frauds or falsifications entails an increase in insurance costs, because it drives companies to allocate this risk to all customers, generally increasing the amount of insurance premiums.

The present invention proposes to solve these and other problems by providing an apparatus and a method for detecting the authenticity or originality of a video or photographic document, intended, in particular but not exclusively, for images related to traffic routes.

The idea underlying the present invention is to detect whether a video content, which can be acquired during a road accident by a general-purpose device (such as, for example, a mobile terminal, a dash cam, a fixed surveillance camera or the like) and relating to a road accident, has been altered, by searching said video content for changes, through automatic processing means, by executing a set of search instructions defining how to identify at least one alteration of the video content following the acquisition thereof.

Thereby, it is possible to automatically verify a high quantity of video contents acquired by means of general-purpose devices which, as is known, do not allow to verify the unalteration of the video, as they produce video contents in digital formats which can be easily modified, since they do not provide for authentication and/or integrity data allowing the verification of the authenticity of the content (i.e., to verify that it has been acquired by a particular device and/or person) and/or of the integrity of said content (i.e., to verify that such a content has not been modified after the acquisition thereof).

Further advantageous features of the present invention are the object of the attached claims.

These features and further advantages of the present invention will become more apparent from the description of an embodiment thereof shown in the accompanying drawings, provided by way of explanation and not by way of limitation, in which:

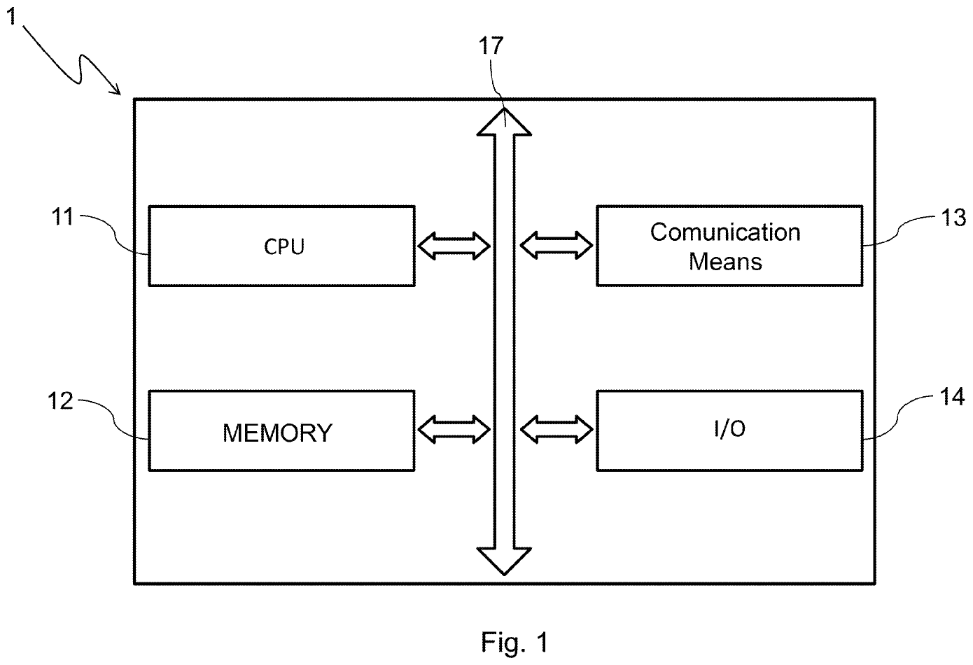

FIG. 1 shows a block diagram which shows the parts included in an apparatus in accordance with the invention;

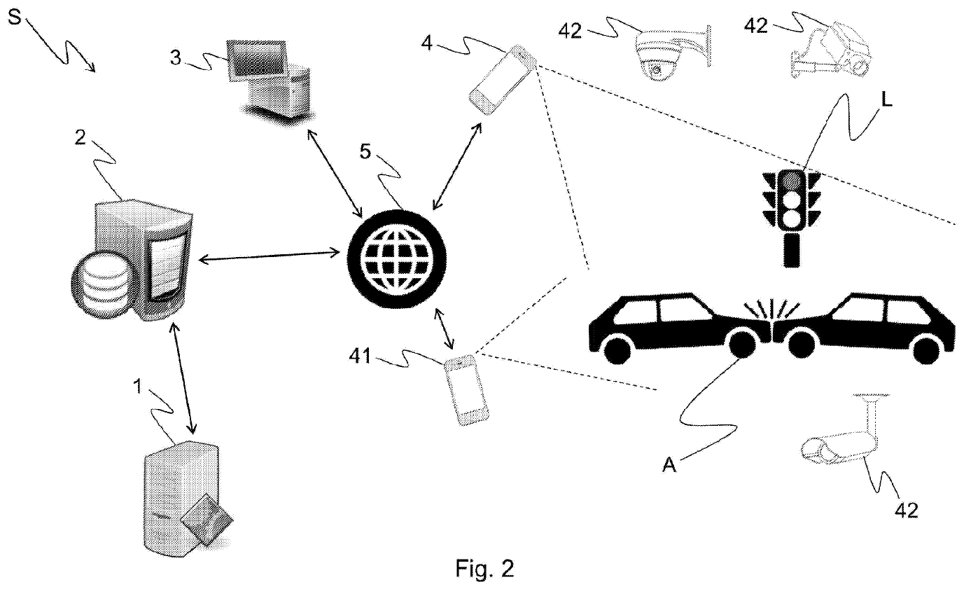

FIG. 2 shows an architecture of a system for acquiring contents relating to road accidents including the apparatus of FIG. 1;

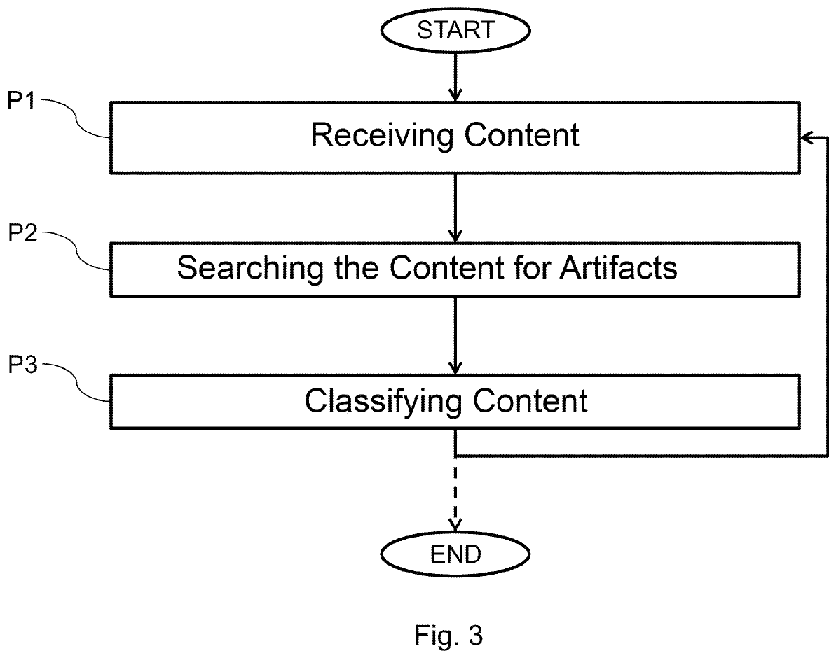

FIG. 3 shows a flow diagram representing a method in accordance with the invention.

The reference to “an embodiment” in this description indicates that a particular configuration, structure or feature is comprised in at least one embodiment of the invention.

Therefore, the terms “in an embodiment” and the like, present in different parts of this description, do not all necessarily refer to the same embodiment. Furthermore, the particular configurations, structures or features may be combined in any suitable manner in one or more embodiments. The references used below are only for the purpose of convenience and do not limit the scope of protection or the scope of the embodiments.

With reference to FIG. 1, an apparatus 1 in accordance with the invention will now be described. An embodiment of said apparatus 1 (which can be a PC, a server or the like) comprises the following components:
processing means 11, such as, for example, one or more CPUs, which control the operation of said apparatus 1, preferably in a programmable manner;
memory means 12, preferably a memory of the Flash and/or magnetic and/or RAM type and/or of another type, which are in signal communication with the control and processing means 11, and where at least the instructions which can be read by the control and processing means 11 are stored in said memory means 12 when the apparatus 1 is in an operating condition, and which preferably implement the method in accordance with the invention;
communication means 13, preferably one or more network interfaces operating according to a standard of the IEEE 802.3 family (known as Ethernet) and/or IEEE 802.11 family (known as Wi-Fi) and/or 802.16 family (known as WiMax) and/or an interface to a data network of the GSM/GPRS/UMTS/LTE type and/or the like, configured to be capable of receiving video contents (such as, for example, videos, photographs or the like) acquired during one or more road accidents by general-purpose devices such as mobile terminals, dash cams, surveillance video cameras or the like;
input/output (I/O) means 14 which can be used, for example, to connect said apparatus 1 to peripheral devices (such as, for example, a touch-sensitive screen, external mass memory units or the like) or to a programming terminal configured to write instructions in the memory means 12 (which the control and processing means 11 shall perform); such input/output means 14 can, for example, comprise a USB, Firewire, RS232, IEEE 1284 interfaces or the like;
a communication bus 17 which allows the exchange of information between the control and processing means 11, the memory means 12, the communication means 13 and the input/output means 14.

As an alternative to the communication bus 17, the control and processing means 11, the memory means 12, the communication means 13 and the input/output means 14 can be connected by means of a star topology.

With reference also to FIG. 2, a system S for verifying whether a video content relating to an event, such as, for example, a road accident A, has been modified, will now be described; such system S comprises the following parts:
the apparatus 1 in accordance with the invention;
a central computer 2 (to which reference will be made in the following description with the term “server”) which is configured to acquire and store video contents relating to road accidents and which is in signal communication with the apparatus 1, preferably by means of a data network (such as, for example, a LAN, an intranet, an extranet or the like);
a user terminal 3 which accesses the central computer 2 by means of a telecommunications network 5, preferably a data network of the public type (such as, for example, the Internet) managed by a network operator, so as to display the video contents stored in the central computer 2 and the reliability status thereof produced by the execution of the method in accordance with the invention by the apparatus 1;
one or more general-purpose devices 41, 42, preferably smartphones 41 and/or tablets and/or dash cams, and/or fixed surveillance video cameras 42, which are in direct or indirect signal communication with the server 2 by means of the telecommunications network 5, and are configured to load the video contents (acquired) by running a program (such as, for example, an Internet browser and/or a specially developed application and/or the like) which exchanges the data with the central computer 2 preferably by means of HTTP (HyperText Transfer Protocol) and/or SOAP (Simple Object Access Protocol), preferably establishing a secure connection by means of the TSL (Transport Layer Security) protocol.

It should be noted that, in the case in which the method in accordance with the invention is executed directly by said server 2, said apparatus 1 can coincide with the server 2, without however departing from the teachings of the present invention. In this configuration, the invention can also be implemented as an additional application (plugin) of a video (or audio/video) content acquisition service relating to road accidents.

With reference also to FIG. 3, the method for detecting the alteration of a video content in accordance with the invention, which is preferably executed by the apparatus 1 when it is in an operating condition, comprises the following steps:
a. a reception step, in which, through the communication means 13, at least one video content relating to an event, such as a road accident A, acquired by a general-purpose device 41, 42 (such as, for example, a mobile terminal, a dash cam, a fixed surveillance video camera, or the like), is received;
b. an alteration search step, in which, through the processing means 11, alterations made after the acquisition thereof, are searched for in said video content, for example by executing a set of search instructions which defines how to identify at least one alteration of the video content following the acquisition thereof;
c. a classification step, in which, through the processing means 11, the content is classified either as altered, if the video content contains at least one of said changes, or as unaltered, if the video content contains no changes.

Thereby, an insurance company or another user (e.g., an expert, an attorney, a judge) can quickly analyze a video content, thus reducing the risk of fraud; in fact, if a video content is classified as unaltered, the insurance company can proceed with the liquidation of the damage with a lower risk of being cheated, while in the event in which said content is classified as altered, the company may proceed in a different manner (for example, by not accepting the video content and/or by having an expert intervene in the evaluation of the video contents and/or by reporting the person who provided said content to the competent authorities and/or other).

The set of search instructions which is executed during the search step of processing means 11 to search for changes can implement a series of steps which serve to determine if the video content is altered or not based on the type of video sensor which acquired it. In fact, the type of video sensor allows to know the response of the sensor to colors and/or to light, therefore allowing to understand if the video was actually acquired by that type of sensor or if it was altered afterwards.

More in detail, the set of search instructions can configure the processing means 11 to perform the following steps:
determining sensor type data defining the type of video sensor which acquired the video content acquired by means of said communication means 13, for example, by reading such data from the metadata included in the (file of the) video content or by requesting said data from the user who desires to transmit said video content to the central computer 2;
determining a set of possible output values on the basis of said sensor type data, in which said set of possible output values contains all the values which can be taken by the points of an image when said image is acquired by a sensor of the type as defined by said sensor type data, since each type of video sensor is not capable of producing in output the totality of possible values but only a reduced sub-set thereof;
searching said video content for values of image points that are not included in the set of possible output values;
classifying the video content as containing changes (i.e., as altered) if the number of points whose value is not contained in the set of possible output values exceeds one or exceeds a threshold value, which is preferably of between 10 and 100.

This set of features advantageously allows to detect video contents which have been modified by using a photo/video retouching software, since the tools that these softwares make available very easily generate changes which remain in the image or in at least one of the frames (in the event in which the video content is a sequence of frames). Thereby, the probability of automatically detecting a counterfeit video content can be advantageously increased, thus reducing the likelihood of an insurance company being cheated.

Alternatively, or in combination with the above, the set of search instructions which is executed during the search step by the processing means 11 to search for changes can implement a series of steps which serve to determine if the video content is altered or not based on the time instant at which such video content was acquired; in fact, knowing the time and optionally also the date and possibly also the weather conditions, it is possible to estimate the amount of light which was there at the time of the accident and to determine if the content was altered afterwards by comparing the luminance data of the video content with the estimated amount of light.

More in detail, the set of search instructions can configure the processing means 11 to perform the following steps:
determining event time data defining a time instant at which the video content (received through the communication means 13) was acquired, for example, by reading such data from the metadata included in the (file of the) video content or by requesting them from the user who desires to transmit said video content to the central computer 2;
determining estimated light data defining the amount of light which could be present at the time of the acquisition of the video content, on the basis of said event time data, for example, by calculating the height of the sun and/or of the moon on the basis of the ephemeris of the sun and/or of the moon;
determining the mean luminance of at least one image (or frame) comprised in said video content;
searching said video content for images (or frames) having a mean luminance value which differs from the estimated light data by a quantity exceeding a threshold value,
classifying the video content as containing changes (i.e., as altered) if the number of images having a mean luminance value differing from the estimated light data by a quantity exceeding said threshold value is greater than one.

This set of features allows to detect the video contents acquired at a different time from the one present in the metadata or declared by the user of the system (for example, because the recorded accident was staged). Thereby, the probability of automatically detecting a video content altered after the acquisition thereof increases advantageously, thus reducing the likelihood of an insurance company being cheated.

As already mentioned above, the mean light can also be calculated based on the weather conditions present at the time of the accident. For this purpose, the apparatus 1 can also be configured to determine the position where the accident occurred and, on the basis thereof, determine the weather conditions present at the time of the accident on the basis of said position and of historical weather data defining the evolution over time of weather conditions in a particular area (for example, the cloud coverage level) and which can preferably be acquired, through the communication means 13, from a weather forecast service (for example, accessible via the Internet) capable of providing the history of all weather conditions in a certain area, for example, of a country, of a continent, or of the entire globe.

More in detail, the set of search instructions can also configure the processing means 11 to determine the mean luminance of at least one image by executing, in addition to the steps defined above, also the following steps:
determining event position data defining the position where the video content (received through the communication means 13) was acquired, for example, by reading such data from the metadata included in the (file of the) video content or by requesting them from the user who desires to transmit said video content to the central computer 2;
determining weather data defining the weather conditions at the time when and in the position where the video content was acquired on the basis of said position data, event time data and historical weather data defining, as already described above, the evolution over time of the weather conditions in an area including the position where the video content was acquired;
determining the estimated light data also on the basis of said weather and position data, in addition to the event time data, for example by calculating the estimated light data on the basis of the ephemeris of the sun and/or of the moon, also taking into account the orography of the area (position data) and the cloud coverage level (weather data) in the place where the road accident occurred.

This further feature further increases the probability of automatically detecting if a video content was altered after the acquisition thereof, as it also takes into account the weather conditions at the time of the road accident. Thereby, the probability of an insurance company being cheated is (further) reduced.

Alternatively, or in combination with the above, the set of search instructions which is executed during the search step by the processing means 11 to trace any changes can implement a series of steps which serve to determine if the video content is altered or not based on the position of the colors and/or of the shapes emitted by luminous signs, such as, for example, a traffic light L, shown in the images of the video content acquired by a general-purpose device 41, 42 and transmitted to the server 2. This allows to (automatically) detect the video contents which have been altered by changing the colors and/or the shapes of indications emitted by luminous signs.

More in detail, the set of search instructions can configure the processing means 11 to perform the following steps:
detecting the presence of at least one luminous sign in at least one image comprised in a video content;
determining luminous indication position data defining the position of the luminous indications emitted by said at least one luminous sign represented in said at least one image, for example, which light (green, yellow or red) of the traffic light is on;
determining luminous indication configuration data defining a color and/or a shape of the luminous indications emitted by said at least one luminous sign represented in said at least one image, for example, the color (red, green, orange) emitted by a generic traffic light or the shape (vertical line, horizontal line, left/right oblique line, triangle, or other shapes) emitted by a traffic light for public transport or by a pedestrian traffic light;
determining if the representation of said at least one luminous sign has been altered (for example, by changing the color and/or the shape of a luminous indication emitted by it) on the basis of said luminous indication position data, said luminous indication configuration data and a set of reference data defining shapes and/or colors, and positions of the luminous indications emitted by the luminous road signs (for example, by implementing the definitions of the luminous sign provided for by the Traffic Code),
classifying the video content as containing changes, if the representation of said at least one luminous sign has been altered.

This set of features allows to detect video contents which have been altered (for example by means of a photo/video retouching software) so as to change the color and/or the shape of the luminous indication emitted by a luminous signal, for example, the video contents in which a traffic light is shown, emitting a green light from the lamp which is in the position above the other lamps, instead of from the lamp which is in the position below the others, or a traffic light emitting a red light from the lamp which is in the position under the other lamps. Thereby, the probability of automatically detecting a video content altered after the acquisition thereof increases advantageously, thus reducing the likelihood of an insurance company being cheated.

Alternatively, or in combination with the above, the set of search instructions which is executed during the search step by the processing means 11 to trace any changes in the image contents can implement a series of steps which allow to determine, by means of a three-dimensional reconstruction technique of the type well known in the background art, if a first image content has been altered by comparing said first video content with at least one second image content. This solution is based on the reconstruction of a three-dimensional scene using at least two video image contents of which the position and orientation of the general-purpose devices 41, 42 which acquired them are known. This approach allows to (automatically) identify any alterations of one of the two contents by analyzing (also automatically) the result of the three-dimensional reconstruction. In particular, if one of the two videos has been altered (for example, by deleting details from the video image content, such as a precedence sign near an intersection, a stop prohibition or the like), the result of the three-dimensional reconstruction will be incomplete, since it will not be possible to place all the objects in the space with a sufficient level of precision.

In other words, the communication means 13 can be configured to receive at least two video contents, and pointing and position data relating to each of said video contents, where said pointing data define at least one position and one orientation which each device 41, 42 had when it was acquiring said content; such pointing and position data can, for example, be generated using the GPS receiver and/or the compass of the smartphone which acquires one of said contents or be specified by the user who sends the content or be already known (in the event of fixed cameras whose position and orientation are known). Furthermore, the set of search instructions can configure the processing means 11 to perform the following steps:
generating a three-dimensional model of the event A on the basis of said at least two image contents and pointing and position data of each of said video contents which, as previously mentioned, define the position and orientation of the device 41, 42 which acquired said content;
searching each one of said at least two contents for the points to which three-dimensional coordinates could not be assigned in said three-dimensional model, i.e., the points which were not placed in said three-dimensional model;
classifying at least one of said at least two video contents as altered, if the number of points to which three-dimensional coordinates could not be assigned exceeds a threshold value.

Thereby, the probability of automatically detecting a video content altered after the acquisition thereof increases advantageously, thus reducing the likelihood of an insurance company being cheated.

Some of the possible variants have been described above, but it is apparent to those skilled in the art that, in the practical implementation, also other embodiments exist, with different elements which can be replaced by others which are technically equivalent. Therefore, the present invention is not limited to the illustrative examples described, but is subject to various amendments, improvements, replacements of parts and equivalent elements without departing from the basic inventive idea, as specified in the following claims.

In this regard, with reference to what was initially stated, although the invention is primarily focused on videos of images acquired with fixed or mobile camcorders, video cameras and cameras, the principles herein disclosed can also be extended to images obtained with infrared rays, radars and the like (i.e., radiations not visible to the human eye), or ultrasound images (i.e., obtained with ultrasonic waves).

1. Apparatus for validation of contents of video images, audio-video data, photographs and the like relating to an event, comprising
communication means adapted to receive an image content that can be acquired, during said event, by a device for generic use, such as a mobile terminal for telecommunications, a dash cam, a fixed surveillance video camera, a camera, or the like,
processing means in communication with said communication means and configured for
searching said image contents for changes, by verifying a plurality of data and/or parameters suitable for identifying at least one alteration made to the image content after acquisition, and
classifying the image content either as altered, if it comprises at least one of said changes, or as unaltered, if the video content contains no changes.

2. Apparatus according to claim 1, wherein the processing means are configured for searching said image content for changes by executing at least the steps of:
determining sensor type data defining the type of sensor that acquired the video image content, associated with said communication means,
determining a set of possible output values on the basis of said sensor type data, wherein said set of possible output values comprises the values that the points of an image can take when said image is acquired by a sensor of the type as defined by said sensor type data;
searching said image content for values of image points that are not included in the set of possible output values,
and wherein the processing means are also configured for classifying the image content as altered, if the number of points whose value is not contained in the set of possible output values exceeds a first threshold value.

3. Apparatus according to claim 1, wherein the processing means are configured for searching said image content for changes by executing the steps of:
determining event time data defining a time instant at which said image content was acquired,
determining estimated light data defining the light level at the time of acquisition of the image content, on the basis of said event time data,
determining the mean luminance of at least one image comprised in said image content,
searching said image content for images having a mean luminance value that differs from the estimated light data by a quantity exceeding a second threshold value,
and wherein the processing means are also configured for classifying the image content as altered, if the number of images having a mean luminance value differing from the estimated light data by a quantity exceeding said second threshold value is greater than one.

4. Apparatus according to claim 3, wherein the processing means are also configured for determining estimated light data by executing the sub-steps of
determining event time data defining the position where said image content was acquired,
determining weather data defining the weather conditions at the time when and in the position where the image content was acquired on the basis of said position data, event time data and historical weather data defining the evolution over time of the weather conditions in an area including the position where said image content was acquired,
determining the estimated light data also on the basis of said weather and position data.

5. Apparatus according to claim 1, wherein said content comprises at least one image, and wherein the processing means are configured for searching said content for changes by executing the steps of
detecting the presence of at least one luminous sign in said at least one image of said content,
determining luminous indication position data defining the position of the luminous indications emitted by said at least one luminous sign represented in said at least one image,
determining luminous indication configuration data defining a colour and/or a shape of the luminous indications emitted by said at least one luminous sign represented in said at least one image,
determining if the representation of said at least one luminous sign has been altered on the basis of said luminous indication position data, said luminous indication configuration data and a set of reference data defining shapes and/or colours and/or positions of the luminous indications emitted by luminous road signs,
and wherein the processing means are also configured for classifying the image content as containing changes, if the representation of said at least one luminous sign has been altered.

6. Apparatus according to claim 5, wherein said at least one luminous sign is a traffic light.

7. Apparatus according to claim 1, wherein the communication means are adapted to receive at least two image contents and pointing and/or position data relating to each one of said image contents, wherein said pointing and/or position data define at least one position and/or one orientation of each device for generic use as it was acquiring said content, and wherein the processing means are configured for searching said image contents for changes by executing the steps of
generating a three-dimensional model of the event on the basis of said at least two image contents and said pointing and position data,
searching each one of said at least two contents for points that were not placed into said three-dimensional model,
and wherein the processing means are also configured for classifying at least one of said at least two image contents as altered, if the number of points to which three-dimensional coordinates could not be assigned exceeds a third threshold value.

8. Apparatus according to claim 1, wherein the event comprises a road accident.

9. Apparatus according to claim 1, wherein the video content comprises images comprised within a predefined time interval, during which said event occurred.

10. Method for validating an image content relating to an event, comprising the following steps:
a. a reception step, wherein said image content acquired during said event by a device for generic use, such as a mobile terminal for telecommunications, a dash cam, a fixed surveillance video camera, a camera, or the like, is received,
b. an alteration search step, wherein, through the processing means, changes are searched for in said video content, which were made after acquisition,
a classification step, wherein, through the processing means, the content is classified either as altered, if the image content contains at least one of said changes, or as unaltered, if the image content contains no changes.

11. Method according to claim 10, wherein the following steps are carried out during the alteration search step
determining sensor type data defining the type of video sensor that acquired the video content received during the reception step,
determining a set of possible output values on the basis of said sensor type data, wherein said set of possible output values contains all the values that the points of an image can take when said image is acquired by a sensor of the type as defined by said sensor type data,
searching said image content for values of image points that are not included in the set of possible output values,
and wherein, during the classification step, the video content is classified as altered, if the number of points whose value is not contained in the set of possible output values exceeds a first threshold value.

12. Method according to claim 10, wherein the following steps are carried out during the alteration search step
determining event time data defining a time instant at which said image content was acquired,
determining estimated light data defining the amount of light that could be present at the time of the acquisition of the images, on the basis of said event time data,
determining the mean luminance of at least one image comprised in said image content,
searching said image content for images having a mean luminance value that differs from the estimated light data by a quantity exceeding a second threshold value,
and wherein, during the classification step, the image content is classified as altered, if the number of images having a mean luminance value differing from the estimated light data by a quantity exceeding said second threshold value is greater than one.

13. Method according to claim 12, wherein the following sub-steps are carried out during the alteration search step in order to determine the estimated light data
determining event position data defining the position where said images were acquired,
determining weather data defining the weather conditions at the time when and in the position where the images were acquired on the basis of said position data, event time data and historical weather data defining the evolution over time of the weather conditions in an area including the position where the images were acquired,
determining the estimated light data also on the basis of said weather and position data.

14. Method according to claim 10, wherein said image content comprises at least one image, wherein the following steps are carried out during the alteration search step
detecting the presence of at least one luminous sign in said at least one image of said content,
determining luminous indication position data defining the position of the luminous indications emitted by said at least one luminous sign represented in said at least one image,
determining luminous indication configuration data defining a colour and/or a shape of the luminous indications emitted by said at least one luminous sign represented in said at least one image,
determining if the representation of said at least one luminous sign has been altered on the basis of said luminous indication position data, said luminous indication configuration data and a set of reference data defining shapes and/or colours and/or positions of the luminous indications emitted by luminous road signs,
and wherein, during the classification step the image content is classified as containing changes, if the representation of said at least one luminous sign has been altered.

15. Method according to claim 14, wherein said at least one luminous sign is a traffic light.

16. Method according to claim 10, wherein, through the communication means, at least two video contents and pointing and position data relating to each one of said image contents are received, wherein said pointing and position data define at least one position and one orientation of each device for generic use as it was acquiring said content, wherein the following steps are carried out during the alteration search step:
generating a three-dimensional model of the event on the basis of said at least two image contents and said pointing and position data,
searching each one of said at least two image contents for points that were not placed into said three-dimensional model,
and wherein, during the classification step, at least one of said at least two image contents is classified as altered, if the number of points to which three-dimensional coordinates could not be assigned exceeds a third threshold value.

17. Method according to claim 10, wherein the event comprises a road accident.

18. Method according to claim 10, wherein the content comprises images comprised within a predefined time interval, during which said event occurred.

19. Computer program product which can be loaded into the memory of an electronic computer, comprising a portion of software code for executing the steps of the method according to claim 10.
